(19) United States
(12) Patent Application Publication
(10) Pub. No.: US 2011/0265596 A1
(43) Pub. Date: Nov. 3, 2011

(54) CABLE AND/OR ROD CONTROL SYSTEM FOR A GEARBOX ON A HEAVY GOODS VEHICLE WITH TILTING CAB

(75) Inventor: Michel Ferron, Voiron (FR)

(73) Assignee: SOCIETE EUROPEENNE DE FABRICATIONS INDUSTRIELLES- SEFI, Tullins (FR)

(21) Appl. No.: 12/672,717

(22) PCT Filed: Aug. 7, 2008
(86) PCT No.: PCT/FR08/01176

§ 371 Date: Jul. 20, 2011

(30) Foreign Application Priority Data
Aug. 9, 2007 (FR) 0705797

(51) Int. Cl. F16H 63/30

(52) U.S. Cl. 74/473.15; 74/473.1

(57) ABSTRACT

The invention relates to a control system, comprising—a first assembly (14), fitted to the cabin (12) of the heavy goods vehicle (11) with at least one control cable, one end of which is designed to be fitted to a gear lever (24) of the heavy goods vehicle, the other end being connected to a operating means such as to move the operating means between first and second positions on a movement of the gear lever (24) by a user, a second assembly (31) mounted on the chassis (13) of the heavy goods vehicle (11) and comprising at least one control cable, one end of which is connected to an operating means and the other end of which is designed to be connected to a gearbox (40) of the heavy goods vehicle such as to bring about a change of gear ratio on a movement of the operating means between the first and second positions, the two operating means cooperating with each other in the operating position of the cabin such that a movement of the operating means of the first assembly (14) brings about a movement of the operating means of the second assembly (31).

### TECHNICAL FIELD

This invention concerns a cable and/or rod control system for a gearbox on a heavy goods vehicle with a tilting cab.

### BACKGROUND

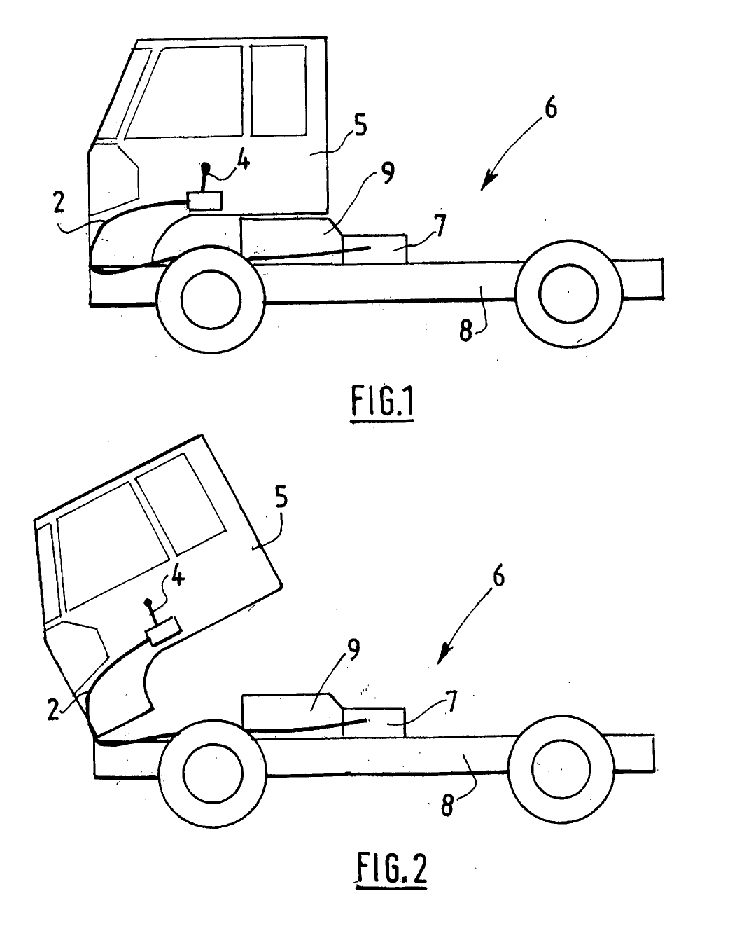

As shown in FIGS. 1 and 2, such a control system comprises, in a known manner, a control cable 2, one end of which is connected to a gear lever 4, housed in the cab 5 of a heavy goods vehicle 6 and the other end of which is connected to a gearbox 7, mounted on the chassis 8 of the heavy goods vehicle and equipped to adapt the engine torque and the rotation direction of the engine 9 of the heavy goods vehicle.

In view of the fact that the cab 5 is mobile between an operating position in which it rests on the chassis 8 of the heavy goods vehicle (represented in FIG. 1) and a tilted position (represented in FIG. 2), it is necessary to pass the control cable 2 at the level of the articulation of the cab 5 in order to avoid risks related to the presence of a taut cable between the cab and the chassis in the tilted position of the cab.

This arrangement of the control cable 2 requires a significant length of cable, which makes assembling the control system on the heavy goods vehicle complex, as this operation is performed after the cab is mounted on the chassis and it requires numerous mechanical components to be bypassed.

In addition, this arrangement of the control cable generates alternate flexing of the cable at the cab articulation as the cab tilts. The alternate flexing of the cable can cause the cable to wear, which may lead to control system malfunctions.

### BRIEF SUMMARY

This invention aims to overcome these disadvantages, and it preferably aims to provide a control system for a gearbox on a heavy goods vehicle that has a simple structure, which does not require a significant length of cable or rod, whilst allowing the control system to be mounted easily on the heavy goods vehicle.

To this effect, this invention concerns a cable and/or rod control system for a gearbox on a heavy goods vehicle with a tilting cab, the cab being mobile between an operating position in which it rests on the chassis of the heavy goods vehicle and a tilted position, characterized in that it comprises:
a first assembly mounted on the cab of the heavy goods vehicle, the first assembly comprising at least one control means and at least one mobile actuation means between at least a first and a second position, one of the ends of the control means being designed to be connected to a gear lever of the heavy goods vehicle housed in the cab and the other end of the control means being connected to the actuation means in order to move the actuation means between its first and second positions as the user moves the gear lever,
a second assembly mounted to the chassis of the heavy goods vehicle, the second assembly comprising at least one control means and at least one mobile actuation means between at least a first and a second position, one of the ends of the control means being connected to the actuation means and the other end of the control means being designed to be fitted to a gearbox on a heavy goods vehicle such as to bring about a change of gear ratio during movement of the actuation means between its first and second positions,
the two actuation means being designed to cooperate with each other in the operating position of the cab such that a movement of the actuation means of the first assembly between its first and second positions brings about a movement of the actuation means of the second assembly between its first and second positions.

Mounting a first assembly on the cab of the heavy goods vehicle and a second assembly on the chassis of the heavy goods vehicle designed to cooperate with each other in the operating position of the cab makes it possible for the control means to avoid passing through the articulation of the cab and therefore to limit the length of the latter.

In addition, this control system structure enables the control system to be easily mounted on the heavy goods vehicle, since the two assemblies can be mounted separately, respectively, on the cab and the chassis, before these are assembled.

Favorably, at least one of the control means is a control cable or a control rod.

Preferably, the actuation means belonging to the first assembly is an actuation lever mounted such that it pivots around an pivot axis, and the actuation means belonging to the second assembly is an actuation lever mounted such that it pivots around a pivot axis, the two actuation levers being designed to cooperate with each other in the operating position of the cab such that the pivoting of the actuation lever belonging to the first assembly around its axis causes the actuation lever belonging to the second assembly to pivot around its axis.

According to one aspect of the invention, each actuation lever comprises at least two contact portions positioned on either side of its pivot axis, the two contact portions of the actuation lever belonging to the first assembly being designed to cooperate with the two contact portions of the actuation lever belonging to the second assembly in the operating position of the cab.

According to another aspect of the invention, at least one damper element is arranged between the two actuation levers at the level of each contact zone between the two actuation levers.

According to another aspect of the invention, the two actuation levers are mounted such that they pivot around a coincident axis. These arrangements enable the wear between the contact portions of the two control levers to be limited.

Favorably, each actuation lever has an approximately T-shape comprising a first and second branch, and the pivot axis of each lever is located approximately in the connection zone between the first and second branches.

According to another characteristic of the invention, the two contact portions of each actuation lever are arranged at the ends of the branch of the corresponding actuation lever extending on either side of the pivot axis of this actuation lever, and the controls means corresponding to this actuation lever is connected to the latter at the free end of the other branch of this actuation lever.

Favorably, the two contact portions of each actuation lever are composed of two returns respectively positioned at the ends of the actuation lever branch extending on either side of the pivot axis of this actuation lever and extending approximately perpendicular to this branch.

Preferably, the connection between a control means and the corresponding actuation lever comprises an axis that is interdependent with the actuation lever around which a pivoting sleeve is mounted which is interdependent with the end of the control means located on the actuation lever side.

Favorably, the first assembly comprises an open unit mounted on the cab, the opening of the unit being located on the chassis side in the operating position of the cab, the actuation lever belonging to the first assembly being housed in the unit.

Preferably, the second assembly comprises an open unit mounted on the chassis, the opening of the unit being located on the cab side in the operating position of the cab, the actuation lever belonging to the second assembly being housed in the unit.

According to one characteristic of the invention, the units belonging to the first and second assemblies comprise means for positioning and locking the units in the operating position of the cab. These arrangements avoid a gap between the units in the operating position of the cab, which could cause poor cooperation of the control levers and therefore a control system malfunction.

Preferably, the means for positioning the units comprise a plurality of pins housed on one of the units, and a plurality of ports housed on the other unit, the pins being designed to be fitted in the ports in order to position the two units in the operating position of the cab.

According to a characteristic of the invention, the means for locking the units comprise a locking plate that is mobile between a unit locking position and a unit release position.

Favorably, each assembly comprises two control cables, namely a gear selection cable and a gear shift cable and two actuation levers, namely a gear selection lever and a gear shift lever, the gear selection levers and cables of the two assemblies cooperating with each other in the operating position of the cab such as to allow a gearbox gear to be selected by the user manipulating the gear lever, and the gear shift levers and cables of the two assemblies cooperating with each other in the operating position of the cab such as to allow a gearbox gear to be engaged by the user manipulating the gear lever.

### BRIEF DESCRIPTION OF THE DRAWIGNS

In any case, the invention will be better understood using the following description, by referring to the diagram representing, as a non-exhaustive example, a form of this control system.

FIGS. 1 and 2 are schematic views of one side of a heavy goods vehicle equipped with a gearbox cable control system according to the prior art, showing two different positions of the heavy goods vehicle cab.

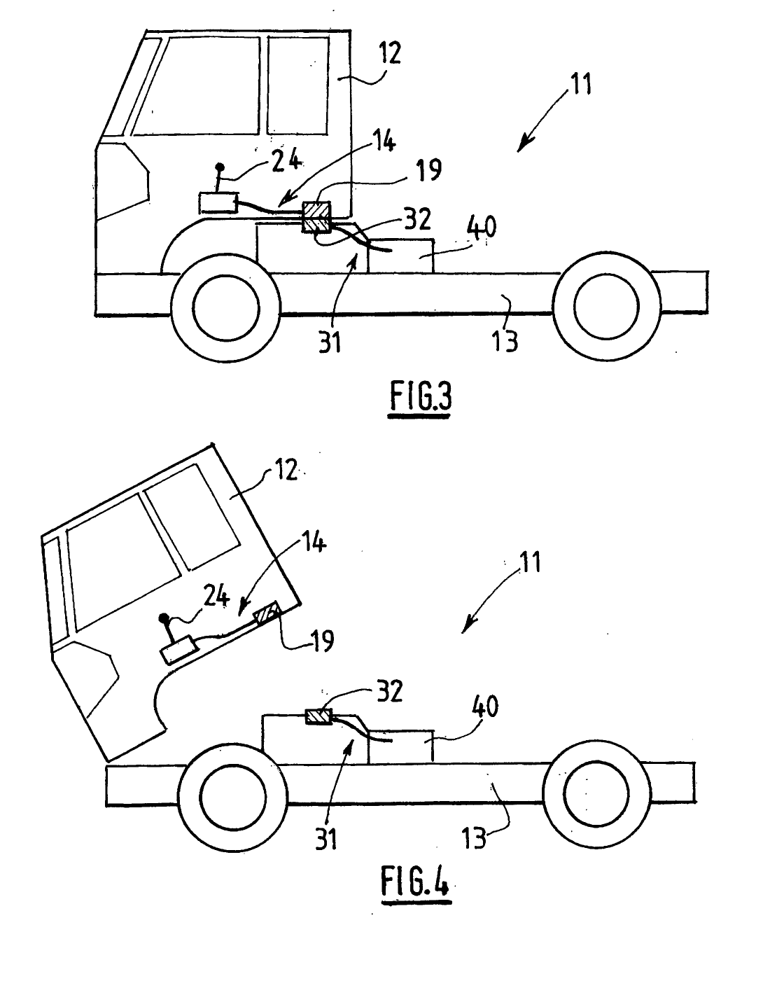

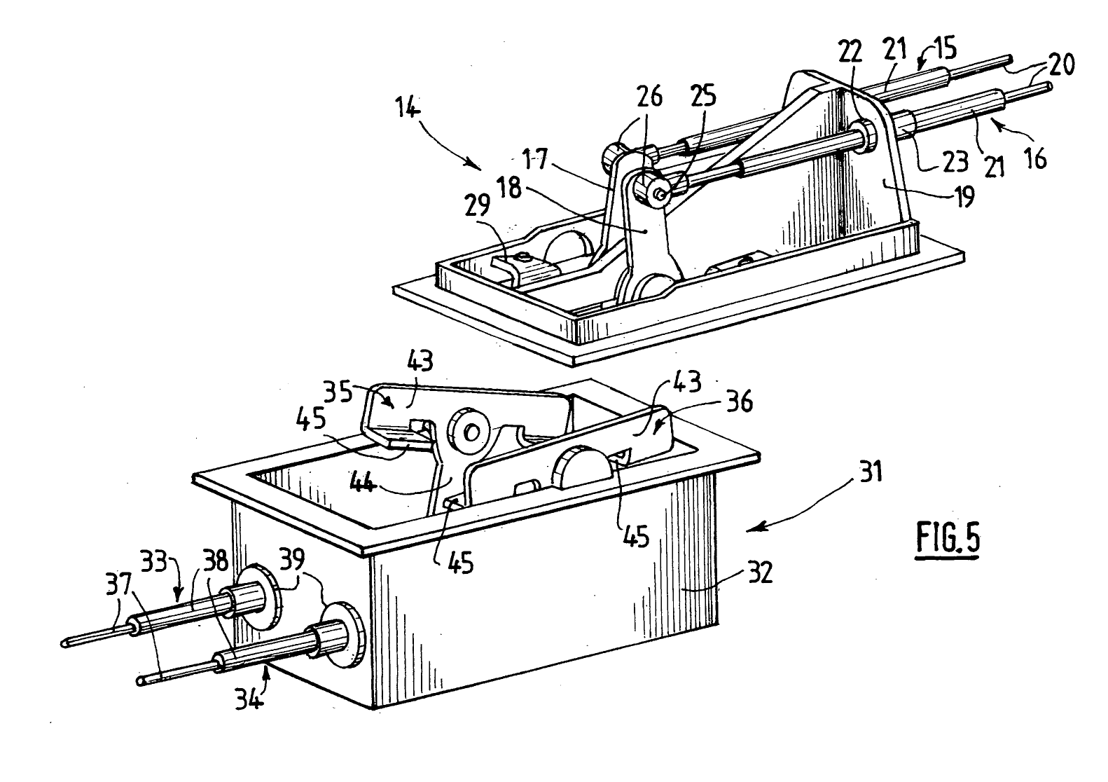

FIGS. 3 and 4 are schematic views of one side of a heavy goods vehicle equipped with a gearbox cable control system according to the invention, showing two different positions of the heavy goods vehicle cab.

FIG. 5 is a perspective view of the control system in FIGS. 3 and 4 before cooperation of the various levers, part of one of the units having been removed for reasons of clarity.

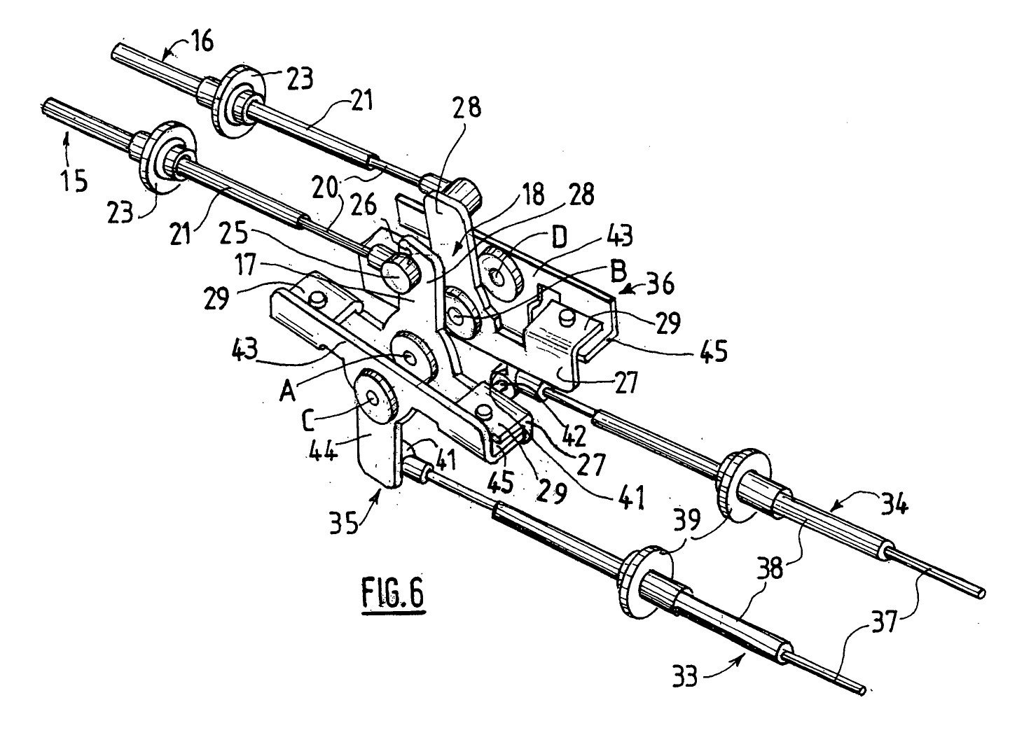

FIG. 6 is a partial perspective view of the control system in FIGS. 3 and 4 in the operating position of the cab, the units housing the various levers having been removed for reasons of clarity.

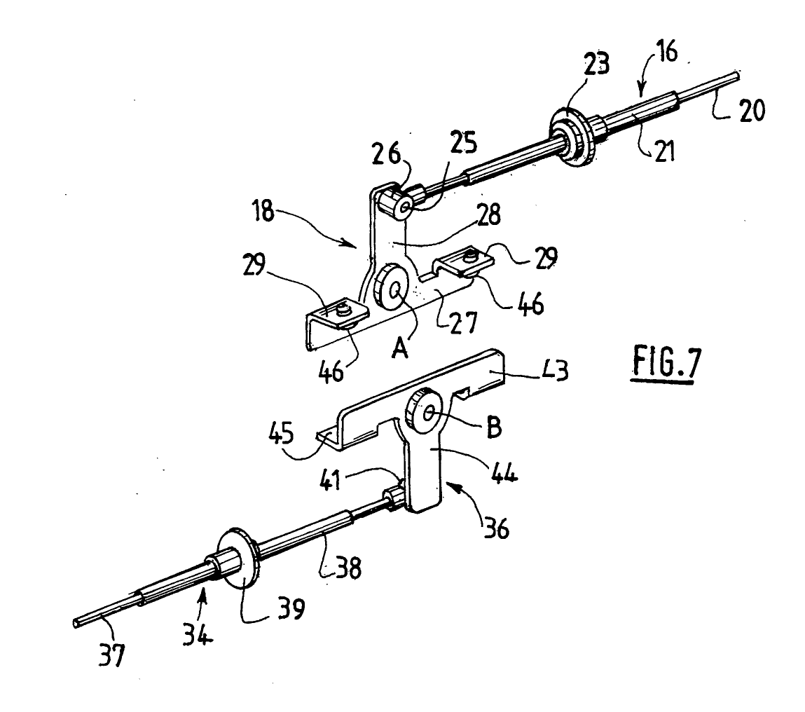

FIG. 7 is a perspective view of the gear shift levers and cables.

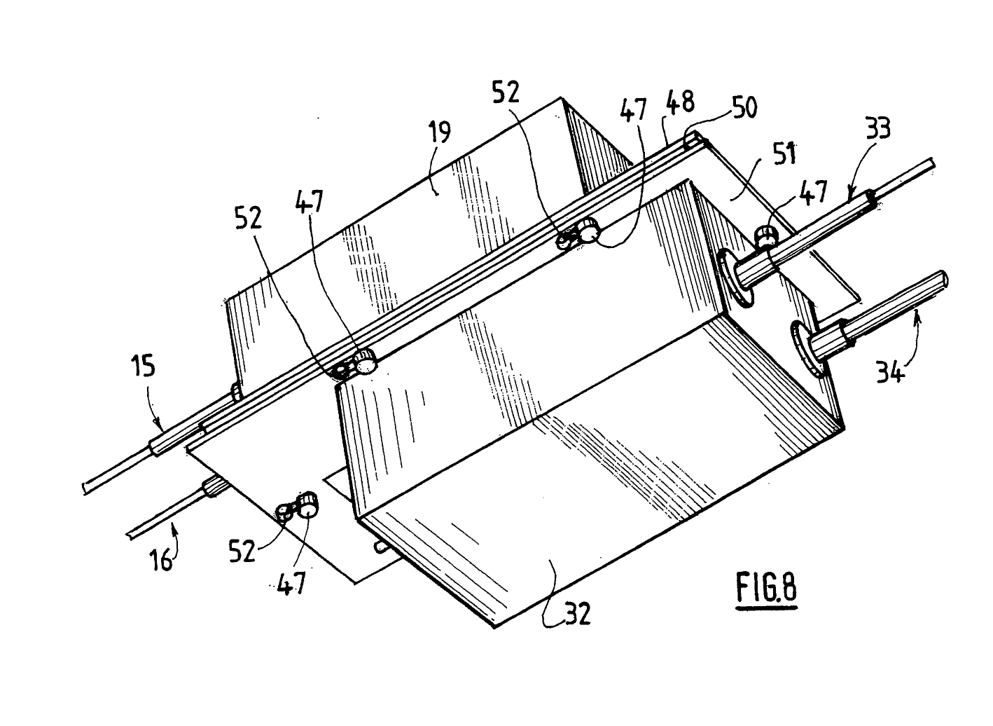

FIGS. 8 and 9 are perspective views of underneath the control system in FIGS. 3 and 4.

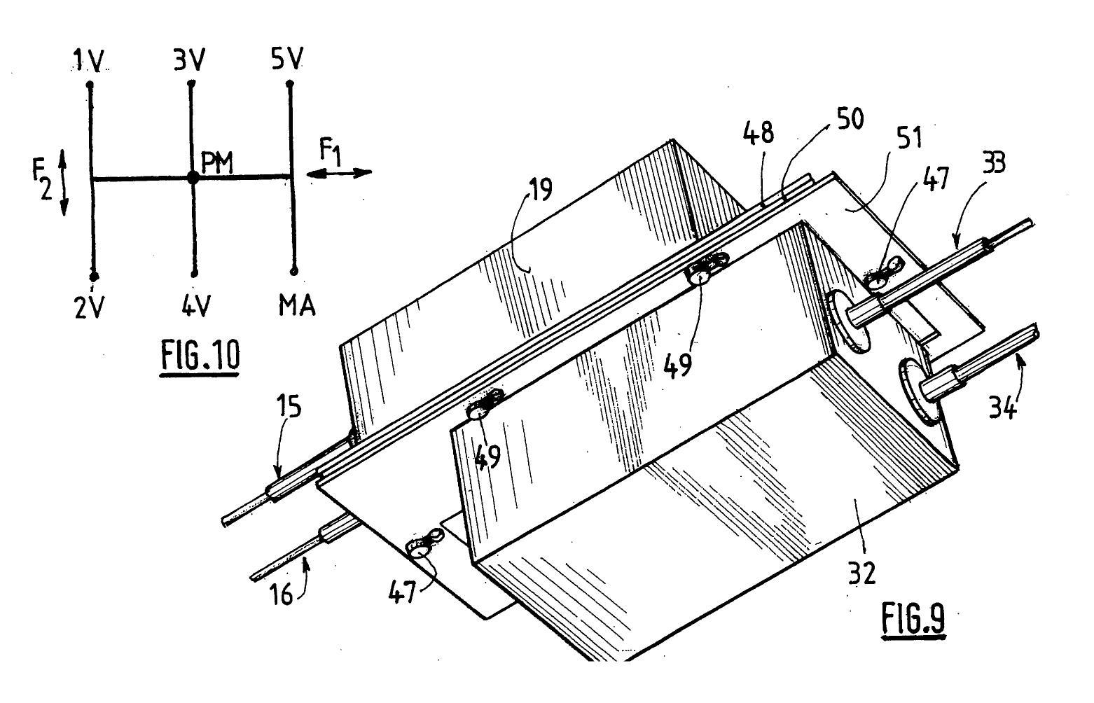

FIG. 10 is a schematic view of the operation of the gear lever for a heavy goods vehicle equipped with a control system according to the invention.

### DETAILED DESCRIPTION OF THE INVENTION

FIGS. 3 and 4 represent a heavy goods vehicle 11 with a tilting cab equipped with a cable control system for a gearbox. The cab 12 of the heavy goods vehicle is mobile between an operating position (represented in FIG. 3) in which it rests on the chassis 13 of the heavy goods vehicle 11 and a tilted position (represented in FIG. 4).

The control system comprises a first assembly 14 mounted on the cab 12 of the heavy goods vehicle 11.

As shown more specifically in FIG. 5, the first assembly 14 comprises an open unit 19 mounted on the cab 12, the opening of the unit 19 being located on the side of the chassis 13 of the heavy goods vehicle 11 in the operating position of the cab 12.

As shown more specifically in FIGS. 5 and 6, the first assembly 14 also comprises a gear selection cable 15 and a gear shift cable 16, as well as a gear selection lever 17 and a gear shift lever 18. The gear selection lever 17 and the gear shift lever 18 are housed in the unit 19 and are each mounted such that they pivot around an axis that is approximately horizontal in the operating position of the cab.

The gear selection cables 15 and the gear shift cable 16 are respectively formed by a metal cable 20 surrounded by a sheath 21 composed of a plastic material.

Each of the gear selection cables 15 and the gear shift cables 16 passes through an opening 22 located in the face of the unit 19 and comprises a sheath end 23 fixed to the unit 19 at the opening of the corresponding passage 22.

One of the ends of the gear selection cable 15 is connected to a gear lever 24 housed in the cab 12 whereas the other end of the gear selection cable 15 is connected to the gear selection lever 17.

The connection between the gear selection cable 15 and the gear selection lever 17 is achieved by an axis 25 which is interdependent with the gear selection lever 17 around which a pivoting sleeve 26 is mounted interdependent with the end of the gear selection cable 15 located on the side of the gear selection lever 17.

Similarly, one of the ends of the gear shift cable 16 is connected to the gear lever 24 whereas the other end of the gear shift cable 16 is connected to the gear shift lever 18.

The connection between the gear shift cable 16 and the gear shift lever 18 is identical to that between the gear selection cable 15 and the gear selection lever 17. Therefore, the end of the gear shift cable 16 located on the side of the gear shift lever 18 comprises a sleeve 26 mounted such that it pivots around an axis 25 which is interdependent with the gear shift lever 18.

The gear selection levers 17 and gear shift levers 18 are identical and each present an approximately T-shape.

As shown more specifically in FIG. 6, each lever 17, 18 comprises a first branch 27 approximately horizontal in the operating position of the cab 12, and a second branch 28 perpendicular to the first branch 27 and approximately vertical in the operating position of the cab 12.

It should be noted that the pivot axis A of the gear selection lever 17 is located approximately in the connection zone between the first and second branches 27, 28 forming the latter. Similarly, the pivot axis B of the gear shift lever 18 is located approximately in the connection zone between the first and second branches 27, 28 forming the latter.

The first branch 27 of each lever from the gear selection levers 17 and gear shift levers 18 comprises two returns 29 positioned respectively at its ends and extending approximately perpendicular to the first branch 27.

A damper element 46 is fixed to each of the returns 29 of the gear selection levers 17 and gear shift levers 18. These various damper elements 46 are positioned on the lower surfaces of the returns 29 and form contact portions.

It should be specified that the axis 25 interdependent with the gear selection lever 17 is housed near the free end of the second branch 28 of the gear selection lever 17. Similarly, the axis 25 interdependent with the gear shift lever 18 is housed near the free end of the second branch 28 of the gear shift lever 18.

The control system comprises a second assembly 31 mounted on the chassis 13 of the heavy goods vehicle 11.

As shown more specifically in FIG. 5, the second assembly 31 comprises an open unit 32 mounted on the chassis 13, the opening of the unit 32 being located on the side of the cab 12 of the heavy goods vehicle 11 in the operating position of the cab 12.

As shown in FIGS. 5 and 6, the second assembly 31 also comprises a gear selection cable 33 and a gear shift cable 34, and a gear selection lever 35 and a gear shift lever 36. The gear selection lever 35 and gear shift lever 36 are housed in the unit 32 and each are mounted such that they pivot around an approximately horizontal axis.

The gear selection cables 33 and gear shift cable 34 are respectively formed by a metal cable 37 surrounded by a sheath 38 composed of plastic.

Each of the gear selection cables 33 and gear shift cables 34 passes through an opening in a face of the unit 32 and comprises a sheath end 39 fixed to the unit 32 at the opening of the corresponding passage.

One of the ends of the gear selection cable 33 is connected to a gearbox lever 40 mounted on the chassis 13 whereas the other end of the gear selection cable 33 is connected to the gear selection lever 35.

The connection between the gear selection cable 33 and the gear selection lever 35 is achieved by an axis which is interdependent with the gear selection lever 35 around which a pivoting sleeve 41 is mounted which is interdependent with the end of the gear selection cable 33 located on the side of the gear selection lever 35.

Similarly, one of the ends of the gear shift cable 34 is connected to the gearbox lever 40 whereas the other end of the gear shift cable 34 is connected to the gear shift lever 36.

The connection between the gear shift cable 34 and the gear shift lever 36 is identical to that between the gear selection cable 33 and the gear selection lever 35. Therefore, the end of the gear shift cable 34 located on the side of the gear shift lever 36 comprises a sleeve 41 mounted such that it pivots around an axis 42 which is interdependent with the gear shift lever 36.

The gear selection levers 35 and gear shift levers 36 are identical and each have an approximately T-shape.

As shown more specifically in FIG. 6, each lever 35, 36 comprises a first branch 43 which is approximately horizontal in the operating position of the cab 12, and a second branch 44 which is perpendicular to the first branch 27 and approximately vertical in the operating position of the cab 12.

It should be noted that the pivot axis C of the gear selection lever 35 is located approximately in the connection zone between the first and second branches 43, 44 forming it. Similarly, the pivot axis D of the gear shift lever 36 is located approximately in the connection zone between the first and second branches 43, 44 forming it.

It should also be noted that the pivot axes A and C of the gear selection levers 17, 35 are joined and that the pivot axes B and D of the gear shift levers 18, 36 are joined.

The first branch 43 of each lever of the gear selection levers 35 and gear shift levers 36 comprises two returns 45 positioned respectively at its ends and extending approximately perpendicular to the first branch 43.

The upper faces of these returns 45 form contact portions.

It should be specified that the axis interdependent with the gear selection lever 35 is positioned near the free end of the second branch 44 of the gear selection lever 35. Similarly, the axis 42 interdependent with the gear shift lever 36 is positioned near the free end of the second branch 44 of the gear shift lever 36.

As shown in FIG. 6, in the operating position of the cab 12, the contact portions positioned on the gear selection levers 17 and gear shift levers 18 belonging to the first assembly 14 respectively rest against the contact portions positioned on the gear selection levers 35 and gear shift levers 36 belonging to the second assembly 31.

In the operating position of the cab 12, the two gear selection levers 17, 35 cooperate with each other such that the pivoting of the gear selection lever 17 around its pivot axis A causes the gear selection lever 35 to pivot around its pivot axis C.

Similarly, in the operating position of the cab 12, the two gear shift levers 18, 36 cooperate with each other such that a pivoting of the gear shift lever 18 around its pivot axis B causes the gear shift lever 36 to pivot around its pivot axis D.

Therefore, the gear selection cables 15, 33 and levers 17, 35 of the two assemblies 14, 31 cooperate with each other in the operating position of the cab 12 in order to enable a gear of the gearbox 40 to be selected by the user manipulating the gear lever 24.

Similarly, the gear shift cables 16, 34 and levers 18, 36 of the two assemblies 14, 31 cooperate with each other in the operating position of the cab 12 in order to enable a gear of the gearbox 40 to be engaged by the user manipulating the gear lever 24.

It should be noted that the units 19, 32 belonging to the first and second assemblies 14, 31 comprise additional positioning means equipped to cooperate with each other in the operating position of the cab.

The positioning means comprise a plurality of pins 47 positioned on a return 48 rotated outwards positioned at the opening of the unit 19, and a plurality of ports 49 positioned on a return 50 rotated outwards housed on the unit 32. The pins 47 are designed to fit in the ports 49 in order to position the two units 19, 31 in relation to each other in the operating position of the cab 12.

The units 19, 32 belonging to the first and second assemblies 14, 31 also comprise means for locking the units. These locking means comprise a locking plate 51 in which openings 52 are arranged each comprising a first circular portion and a second oblong portion.

The locking plate is mobile between a unit locking position (represented in FIG. 8) in which the oblong portions of the openings 52 cooperate with the pins 47 in order to prevent the latter from being retracted away from the ports 49, and a unit release position (represented in FIG. 9) in which the circular portions of the openings 52 are located opposite the ports 49 in order to enable the pins 47 to be retracted out of the ports 49.

The operation of the control system will now be described.

As shown in FIG. 10, when a user wishes to change gear, he must first move the gear lever 24 according to the double arrow F1 in order to select the desired gear, then he must move the gear lever 24 according to the double arrow F2 in order to engage the desired gear.

For example, when a user wishes to shift from neutral PM to first gear 1V, he must first move the gear lever 24 to the left according to the double arrow F1, then he must move the lever forward according to the double arrow F2.

When a user wishes to shift from neutral PM to reverse gear MA, he must first move the gear lever 24 to the right according to the double arrow F1, then he must move the lever to the rear according to the double arrow F2.

The movement of the gear lever 24 according to the double arrow F1 causes the metal cable 20 of the gear selection cable 15 to move, and more specifically, causes the sleeve 26 connected to the gear selection lever 17 to move. This movement of the sleeve 26 causes the gear selection lever 17 to pivot around its pivot axis A. Through the intermediary of the returns 29, 45 and the damper elements 46, this pivoting of the gear selection lever 17 causes the gear selection lever 35 to pivot around its pivot axis C. This pivoting of the gear selection lever 35 around its pivot axis C causes movement of the sleeve 41 which is interdependent with the end of the metal cable 37 of the gear selection cable. This movement of the sleeve 41 moves the gearbox lever 40 into a position corresponding to the gear selection desired.

Similarly, the movement of the gear lever 24 in the direction of the double arrow F2 causes the metal cable 20 of the gear shift cable 16 to pivot, and more specifically, causes the sleeve 26 connected to the gear shift lever 18 to move. This movement of the sleeve 26 causes the gear shift lever 18 to pivot around its pivot axis B. Through the intermediary of the returns 29, 45 and damper elements 46, this pivoting of the gear shift lever 18 cases the gear shift lever 36 to pivot around the pivot axis D. This pivoting of the gear shift lever 36 around its pivot axis D causes movement of the sleeve 41 which is interdependent with the end of the metal cable 37 of the gear shift cable. This movement of the sleeve 41 moves the gearbox lever into a position corresponding to the gear shift desired.

It should be specified that pressure on the sleeve 26 of the gear selection lever 17 or gear shift lever 18 causes traction of the sleeve 41 of the gear selection lever 35 or the gear shift lever 36, and that traction of the sleeve 26 of the gear selection lever 17 or the gear shift lever 18 causes pressure on the sleeve 41 of the gear selection lever 35 or the gear shift lever 36.

It should be noted that the unit 32 is mounted such that it floats on the chassis 13 so that in the tilted position of the cab 12, the unit 32 rests on the chassis 13, and that in the operating position of the cab, the latter is only interdependent with the unit 19 mounted on the cab 12. These arrangements ensure perfect operation of the control system when suspension systems are interposed between the cab 12 and the chassis 13.

It goes without saying that the invention is not limited to the embodiment of this control system, described above by way of example; on the contrary, it embraces all the variants of the embodiment. Therefore, it can be noted that the control cables 15, 16, 33, 34 could be replaced by control rods.

1. A cable and/or rod control system for a gearbox on a heavy goods vehicle with a tilting cab, the cab being mobile between an operating position in which the cab rests on a chassis of the heavy goods vehicle and a tilted position, the system comprising:
a first assembly mounted on the cab of the heavy goods vehicle, the first assembly comprising at least one control means and at least one actuation means, which is mobile between at least a first and a second position, one ends of the controls means being designed to be connected to a gear lever of the heavy goods vehicle housed in the cab and another end of the control means being connected to the actuation means in order to move the actuation means between its first and second positions when the user moves the gear lever,
a second assembly mounted on the chassis of the heavy goods vehicle, the second assembly comprising at least one control means and at least one actuation means, which is mobile between at least a first and second position, one of the ends of the control means being connected to the actuation means and the other end of the control means being designed to be connected to a gearbox of the heavy goods vehicle in order to bring about a change of gear ratio on movement of the actuation means between its first and second positions,
the two actuation means being designed to cooperate with each other in the operating position of the cab such that movement of the actuation means belonging to the first assembly between its first and second positions causes movement of the actuation means belonging to the second assembly between its first and second positions.

2. The control system according to claim 1, wherein at least one of the control means is a control cable or a control rod.

3. The control system according to claim 1, wherein the actuation means belonging to the first assembly is an actuation lever, mounted such that it pivots around a first pivot axis, and the actuation means belonging to a second assembly is an actuation lever, mounted such that it pivots around a second pivot axis, the two actuation levers being designed to cooperate with each other in the operating position of the cab so that pivoting the actuation lever belonging to the first assembly around the first axis causes the actuation lever belonging to the second assembly to pivot around the second axis.

4. The control system according to claim 3, wherein each actuation lever comprises at least two contact portions arranged on either side of its pivot axis, the two contact portions of the actuation lever belonging to the first assembly being designed to cooperate with the two contact portions of the actuation lever belonging to the second assembly in the operating position of the cab.

5. The control system according to claim 4, wherein at least one damping element is arranged between the two actuation levers, at each contact area between the two actuation levers.

6. The control system according to claim 3, wherein the two actuation levers are mounted such that they pivot around a coincident axis.

7. The control system according to claim 3, characterized in thatwherein each actuation lever has an approximately T-shape comprising a first and a second branch, and that the pivot axis of each lever is located approximately in a connection zone between the first and second branches.

8. The control system according to claim 4, wherein the two contact portions of each actuation lever are arranged at ends of a branch of the corresponding actuation lever extending either side of the pivot axis of this actuation lever, and wherein the control means corresponding to this actuation lever is connected to a free end of another branch of this actuation lever.

9. The control system according to claim 8, wherein the two contact portions of each actuation lever are composed of two returns positioned respectively at the ends of the branch of the actuation lever extending either side of the pivot axis of this actuation lever and extending approximately perpendicular to this branch.

10. The control system according to claim 3, wherein a connection between a control means and the corresponding actuation lever comprises an axis which is interdependent with the actuation lever around which a pivoting sleeve is mounted which is independent with the end of the control means located on the side of the actuation lever.

11. The control system according to claim 3, wherein the first assembly comprises an open unit mounted on the cab, an opening of the unit being located on a side of the chassis in the operating position of the cab and wherein the actuation lever belonging to the first assembly is housed in the unit.

12. The control system according to claim 2, wherein the second assembly comprises an open unit mounted on the chassis, an opening of the unit being located on a side of the cab in the operating position of the cab, and wherein the actuation lever belonging to the second assembly is housed in the unit.

13. The control system according to claim 11, wherein the units belonging to the first and second assemblies comprise means for positioning and locking the units in the operating position of the cab.

14. The control system according to claim 13, wherein the means for positioning the units comprise a plurality of pins positioned on one of the units and a plurality of ports positioned on the other unit, the pins being designed to be received in the ports in order to position the two units in relation to each other in the operating position of the cab.

15. The control system according to claim 13, wherein the means for locking the units comprise a locking plate, which is mobile between a unit locking position and a unit release position.

16. The control system according to claim 1, wherein each assembly comprises two control cables, including a gear selection cable and a gear shift cable and two actuation levers, including a gear selection lever and a gear shift lever, the gear selection levers and cables of the two assemblies cooperating with each other in the operating position of the cab in order to enable a gear of the gearbox to be selected by a user manipulating the gear lever, and the gear shift levers and cables of the two assemblies cooperating with each other in the operating position of the cab in order to enable a gear of the gearbox to be engaged by the user manipulating the gear lever.
